(19) United States
(12) Patent Application Publication
(10) Pub. No.: US 2003/0004706 A1
(43) Pub. Date: Jan. 2, 2003

(54) Natural language processing system and method for knowledge management

(76) Inventors: Thomas W. Yale, Sherman, IL (US); Lawrence L. Stone, Sherman, IL (US)

Correspondence Address: Richard C. Litman, LITMAN LAW OFFICES, LTD., P.O. Box 15035, Arlington, VA, 22215, US

(21) Appl. No.: 09/891,465

(22) Filed: Jun. 27, 2001

(51) Int. Cl. G06F 17/27

(52) U.S. Cl. 704/9

(57) ABSTRACT

A computerized natural language processing system and method for knowledge management. The system is made up of a computer keyboard for entering data into the system, at least one server computer having a processor, an area of main memory for executing program code under the direction of the processor, and a disk storage device for storing data and program code. Computer program code stored in disk storage device and executing in the main memory is under the direction of the processor and a knowledge repository with a relational database structure with a plurality of database listings that are integrated and managed within the knowledge repository. A computerized natural language processing method for knowledge management of data, between the system and a user, is also disclosed and involves performing lexical analysis, performing structural analysis, performing data management steps and generating a response in proper grammatical form.

### BACKGROUND OF THE INVENTION

1. Field of the Invention

The present invention relates to a natural language processing system and method for knowledge management.

2. Description of the Related Art

A person's effectiveness in performing any kind of work involves his or her ability to process and exchange information. This is especially true today, in a society with a great dependence on computers. In the past, information was primarily expressed in the form of the English language. Today, information is more commonly expressed in database fields, spreadsheet cells and passages in text files and e-mail.

The mode of communication has shifted. To operate computers and to function appropriately in most kind of work, requires us to be familiar with the computer's language instead of our own. Consequently, despite the tremendous strides in interface design and refined programming methods, computers are generally quite difficult to use.

It seems only natural that, if the computer bore more of the responsibility in interacting with the user in the user's own language (instead of the other way around), the user could perform tasks, diagnose problems and generally operate the computer much more easily. The user could concentrate more on how to perform work and less on how to reinterpret the information involved for the benefit of the machine.

However, it is difficult to build software that can actually manage English language information in a meaningful way, or to use it to operate other software with English commands. The reason is that English is the product of centuries of evolution. It is irregular and inexact in nature and it has a multitude of grammatical exceptions, which makes English ill suited for computer processing.

This is reflected in the related art and the following patents. U.S. Pat. No. 4,688,195 issued to Thompson et al. outlines the use of a system for interactively generating a natural language input interface, without any computer programming work being required. The natural language menu interface thus generated provides a menu selection technique where a totally unskilled computer user, who need not even be able to type, can access a relational or hierarchical database, without any error.

U.S. Pat. No. 5,056,021 issued to Ausborn, outlines the use of a method and system for abstracting meanings from natural language words. Each word is analyzed for its semantic content by mapping into its category of meanings from within each of four levels of abstraction. The preferred embodiment uses Roget's Thesaurus and Index of Classification to determine the levels of abstraction and category of meanings for words.

U.S. Pat. No. 5,237,502 issued to White et al., outlines the use of a system and method of analyzing natural language inputs to a computer system for creating queries to databases. In the process of such analysis, it is desirable to present to the user of the system an interpretation of the created query for verification by the user that the natural language expression has been transformed into a correct query statement.

U.S. Pat. No. 5,442,780 issued to Takanashi et al., outlines the use of a database information retrieval system, which includes a parser for parsing a natural language input query into constituent phrases with an analysis of the syntax of the phrase. The parser may make use of tables and or dictionaries to aid in terminology identification and grammatical syntax analysis. The system also includes virtual tables for converting phrases from the natural language query into retrieval keys that are possessed by the database.

U.S. Pat. No. 5,748,974 issued to Johnson, outlines the use of user interfaces for computer systems and, more particularly, to a multimodal natural language interface that allows users of computer systems conversational and intuitive access to multiple applications. The term “multinodal” refers to combining input from various modalities, such as combining spoken, typed or handwritten input from a user.

U.S. Pat. No. 6,081,774 issued to de Hita et al., outlines the use of an information retrieval system that represents the content of a language based database being searched as well as the user's natural language query. In accordance with one aspect of the invention, the information retrieval system includes a non-real-time development system for automatically creating a database index having one or more content based database key words of the database. There is also a real-time retrieval system that, in response to a user's natural language query, searches the keyword index for one or more content based query key words derived from the natural language query.

European patent application number 87308955.1 issued to Ali et al., outlines the use of a domain independent natural language interface for an existing entity relationship database management system. Syntactically, it relies on augmented phrase structure grammar which retains the convenience and efficiency of semantic grammar while removing some of its ad hoc nature. More precisely, it is syntactic domain independent grammar augmented with semantic variables used by the parser to enforce the semantic correctness of a query.

Although each of the previously described patents is useful in some respect, none directly address the problems involved with a user easily exchanging natural language information with a knowledge management system. If such a problem could be solved, it could greatly simplify how persons not familiar with computer technology work with computers.

None of the above inventions and patents, taken either singularly or in combination, is seen to describe the instant invention as claimed. Thus a natural language processing system for knowledge management solving the aforementioned problems is desired.

### SUMMARY OF THE INVENTION

The invention is a computerized natural language processing system and method for knowledge management. The system is made up of a computer keyboard for entering data into the system, at least one server computer having a processor, an area of main memory for executing program code under the direction of the processor, and a disk storage device for storing data and program code. Computer program code stored in disk storage device and executing in the main memory is under the direction of the processor and a knowledge repository with a relational database structure with a plurality of database listings that are integrated and managed within the knowledge repository. A computerized natural language processing method for knowledge management of data, between the system and a user, is also disclosed and involves performing lexical analysis, performing structural analysis, performing data management steps and generating a response in proper grammatical form.

Accordingly, it is a principal object of the invention to provide a simplified system and method of using a computer.

It is another object of the invention to provide a computerized system and method for natural language processing.

It is a further object of the invention to provide a computerized system and method for knowledge management that utilizes conceptual dependency.

Still another object of the invention is to provide a computerized system and method for allowing a user to interact with a computer using his own native language.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of a natural language processing system for knowledge management according to the present invention.

FIG. 2 is an outline of a natural language processing an overall method for knowledge management according to the present invention.

FIG. 3 is an outline of an lexical analysis according to the present invention.

FIG. 4, FIG. 5, FIG. 6 and FIG. 7 are examples of lexical analysis data according to the present invention.

FIG. 8 is an outline of a structural analysis according to the present invention.

FIG. 9A is a table of sentence type data according to the present invention.

FIG. 9B is an example of POS specific fragment analysis according to the present invention.

FIG. 9C is an example of POS specific transformational analysis according to the present invention.

FIG. 10 and FIG. 11 is an example of a conceptual dependency representation and related data according to the present invention.

FIG. 12 is an outline of data management steps according to the present invention.

FIG. 13 is an outline of response generation according to the present invention.

Similar reference characters denote corresponding features consistently throughout the attached drawings.

### DETAILED DESCRIPTION OF THE PREFERRED EMBODIMENT

The present invention is computerized natural language processing system 10 and method 100 for knowledge management. The present invention allows a user to conduct information management with a computer in the natural language of the user. In the preferred embodiment, the native language of the user is assumed to be English and the preferred form of communication is type-written text.

The system 10 comprises an input means 20 for entering data into the system 10, at least one server computer 30 having a processor 40, an area of main memory 50 for executing program code under the direction of the processor 40 and a disk storage device 60 for storing data and program code. The computer program code is stored in the disk storage device 60 and executes in main memory 50 under the direction of the processor 40.

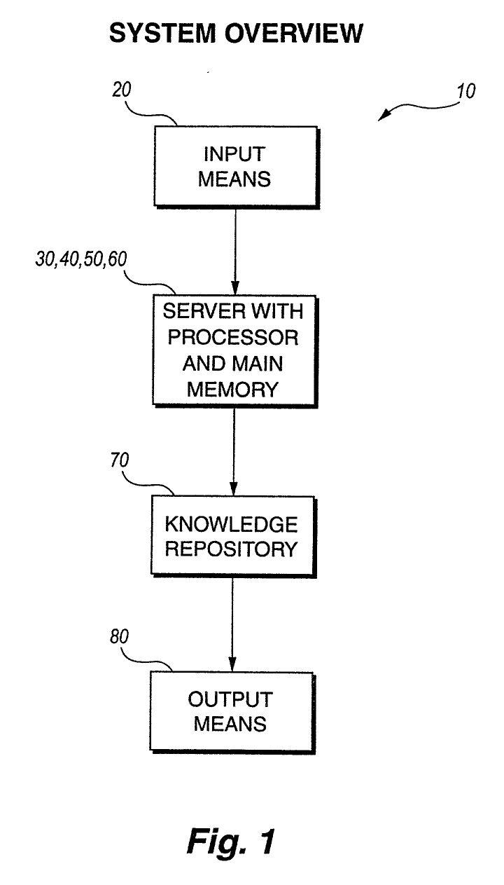

A knowledge repository 70 with a relational database structure and a plurality of database listings that are integrated and managed within the knowledge repository 70 is provided. An output means 80 for generating a response to the data originally input in the system 10 is also provided. The input means 20 for the system 10 is a computer keyboard (not shown) and the output means 80 for generating a response to the data originally input in the system 10, is a computer monitor and printer (not shown). This is shown in FIG. 1.

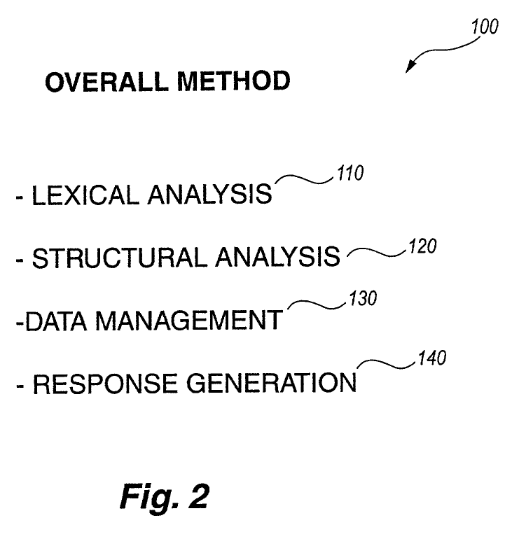

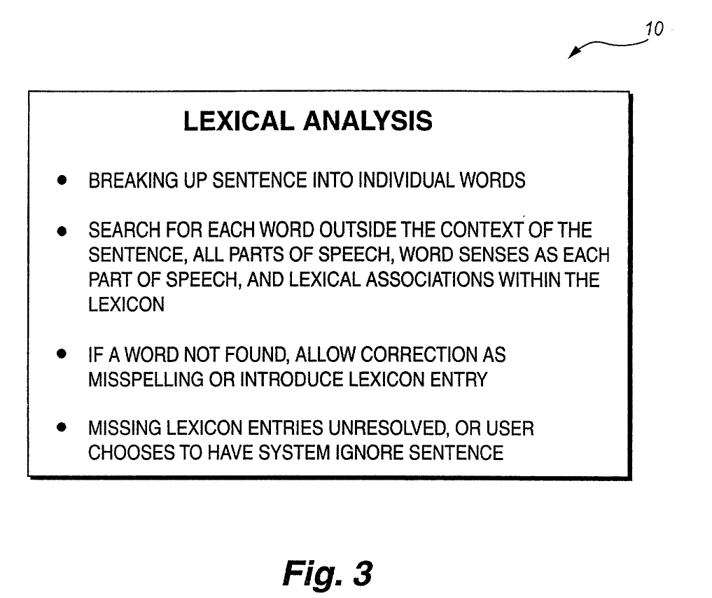

An overall method 100 can be expressed in terms of lexical analysis 110, structural analysis 120, data management 130 and response generation 140, as shown in FIG. 2.

Once the user enters the data or information as a sentence, whether that sentence is a declarative statement or question, the system 10 seeks individual words utilizing the user's sentence in a lexicon to collect lexical data on each word. In the lexicon, nouns, verbs, adjectives and adverbs are organized into synonym sets, each representing one underlying lexical concept. Lexical relations common in the study of lexicography, such as antonyms, hyponyms, hypernyms, holonyms, troponyms and meronyms link the synonym sets together.

For example, the word “board” can signify either a piece of lumber or a group of people assembled for some purpose. The synonym sets (board, plank) and (board, committee) can serve as unambiguous designators of those two meanings of the word “board”. Synonyms sets are then connected with semantic relations. For example, a series of superordinate associations or hypernyms, in the lexicon states that an “oak” is a “tree” which is a “plant” which is an “organism”.

Lexical analysis data involves the parts of speech, word senses and semantic associations to other words outside the context of the user's sentence. The lexicon in which this lexical data is sought is divided into two parts for words which are “identifiers” and “non-identifiers”. Identifiers are words such as articles, conjunctions, propositions, pronouns and other words which are unlikely to be misconstrued to have any other grammatical function in a sentence. Those words in the sentence which are non-identifiers, which have more than one possible part of speech (hence more than one possible grammatical function) within the context of a sentence, are identified along with the possible parts of speech they may have within a sentence.

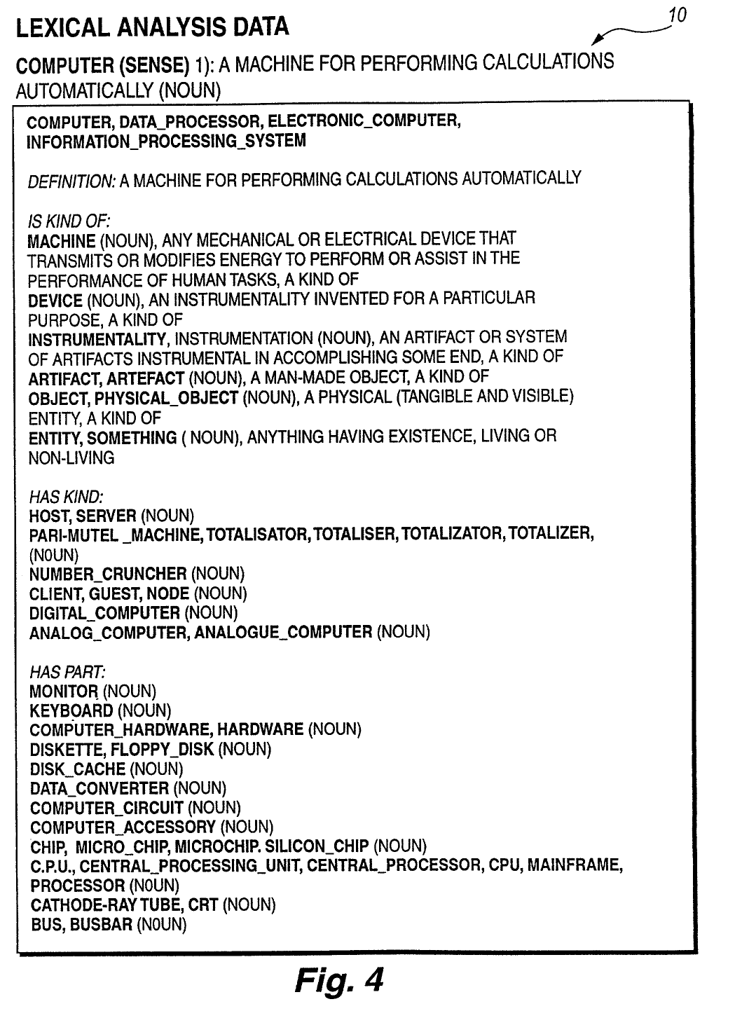

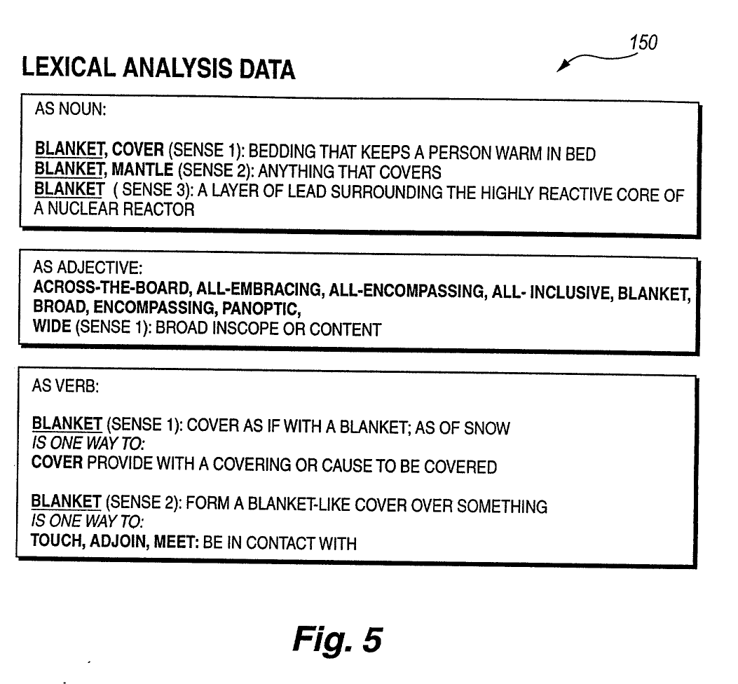

A lexical data search of the non-identifier “computer” results in generating the lexical analysis data 150 depicted in FIG. 4. The lexicon may include multiple parts of speech, and as individual parts of speech and multiple word senses, as for the non-identifier “blanket”.

Depending on applicable parts of speech, there may be lexical associations present for a word sense, as illustrated in FIG. 5 for the verb form of the word “blanket”.

An example of lexical associations for the a non-identifier word such as the verb “go” is also depicted in FIG. 6.

In the lexicon, the word senses of non-identifiers as possible verbs are linked to a database structure which lists conceptual dependency definitions of the verb sense. These definitions serve as a template from which the conceptual dependency representation of the entire user sentence is constructed. For example, the word “send” is defined as:

s: entity1 t*+DO o:entity2-c-->t*+PTRANS s:entity2 d:place1-->place2

where s:, o: and d: are markers for subjective, objective and directional clauses, respectively (there are 12 different clauses available);

DO and PTRANS verb primatives, defined as “performing an action” and “performing physical motion”, respectively (there are 21 different verb primatives);

t*+ are verb operators, indicating the time, mode and manner of the action described by the verb primative; and

-c--> is an interpredicate connector indicating the action described in one predicate causing the action of the predicate following it.

This example definition above is described in FIG. 7.

This includes for each verb sense one or more sentence frames, which specify the subcategorization features of the verbs in the synonym set by indicating the kinds of sentences they can occur in. They aid in identifying the verb sense of a word based on the grammatical structure in which the verb is used in the user's sentence.

For example, the word “write”, in the sense of “produce a literary work” is restricted to the sentence frames “Somebody --s something” as in “Longfellow wrote the book,” whereas write in the sense of “communicate with writing” is restricted to the sentence frames “Somebody --s somebody,” as in “John writes Bob,” and “Somebody --s to somebody,” as in “John writes to Bob.”

The system 10 identifies the parts of speech of a word by its syntactic inflection codes as listed in the lexicon. Syntactic inflection involves codes to convert particular words from its nominal form to other forms. These forms involve converting singular nouns to plural nouns (e.g., “ball” to “balls” and “fungus” to “fungi”), infinitive verbs to simple past, third person singular present, passive participles and active participles (e.g., “ride” to “rode, rides, ridden and riding” and “go” to “went, goes, gone, going”), and nominal adjectives to comparative and superlative forms (e.g., “efficient” to “more efficient, most efficient” and “good” to “better, best”).

Words with multiple parts of speech have multiple syntactic inflection codes. For example, “clean” is both a verb and adjective, its lexicon entry includes a corresponding syntactic inflection code as a verb and an adjective, allowing the system 10 to recognize the forms “cleans, cleaned, cleaning, cleaner, cleanest”.

If a word in the user's statement is not found in the lexicon, it may be misspelled, and the user may correct the spelling. If not, the user has the option, through a graphical interface, of entering the word as a new lexicon entry, designating its possible parts of speech and lexical relationships to existing lexicon entries.

For example, an unknown word “widget” may be designated as a noun being “a kind of” {instrument and instrumentality}. This is analogous to a human's ability to learn new words by relating them to concepts with which the human is already familiar. The user also has the option to have the system ignore the entered sentence altogether, allowing entry of a new sentence.

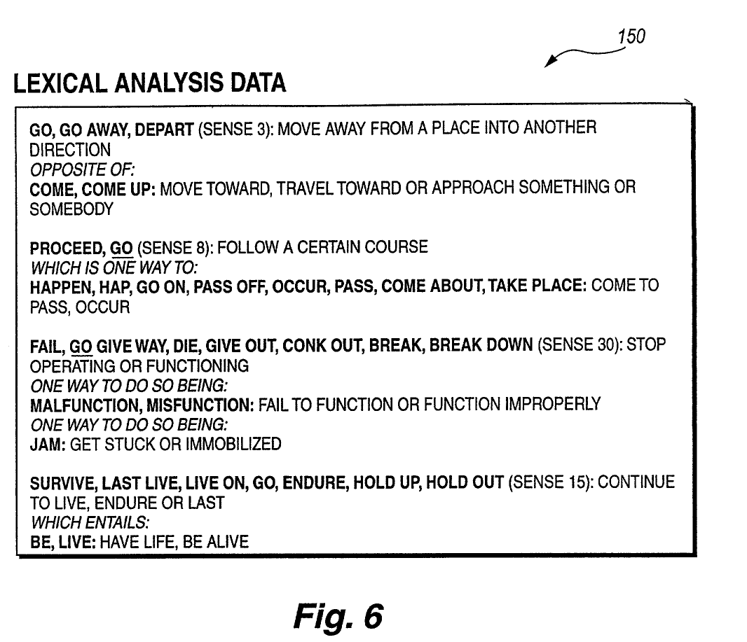

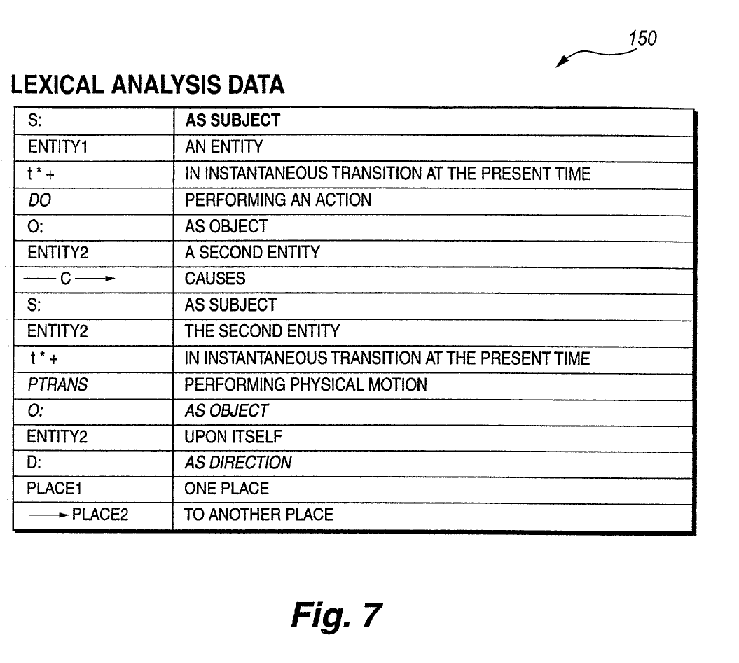

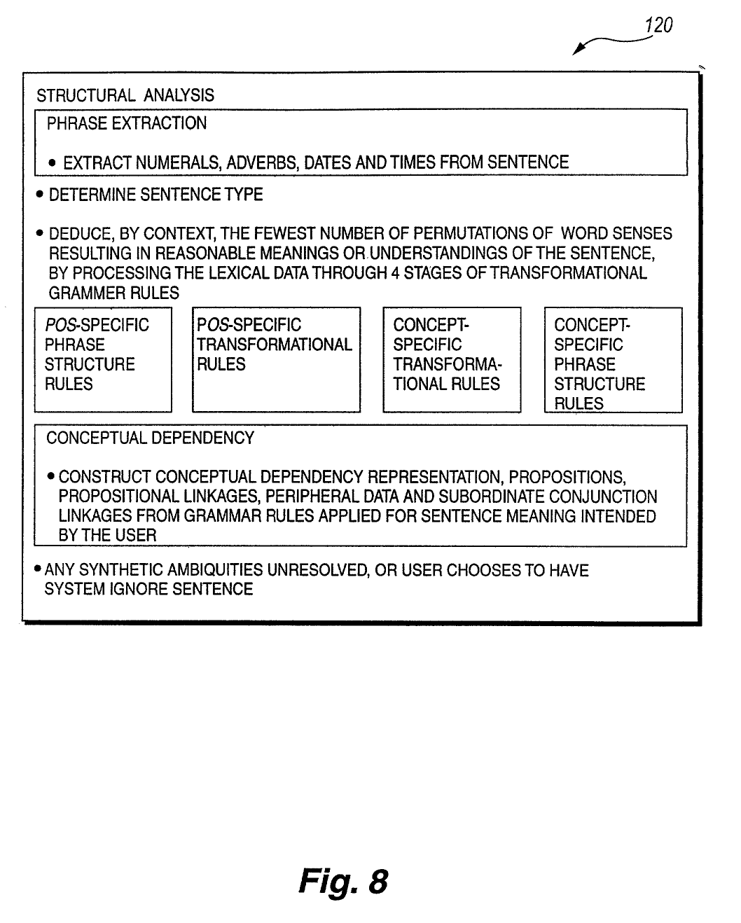

FIG. 8 outlines the process of undergoing structural analysis 120 on an entered set of data or information (expressed in a user sentence). In this system 10, structural analysis attempts to deduce, by context, the part of speech and sense of each word in the user sentence based on the vast plurality of such data provided by a lexical analysis 110. The system 10 therefore assumes that the user statement “means one thing” by parsing it on the basis of each word recognized as only one part of speech and only one intended sense.

The lexical analysis data provides ample criteria for the system 10 to reasonably assume the permutation of parts of speech and word senses that accurately reflects the meaning the user has intended. This criteria is analogous to knowledge of language and everyday experience, with which a human effortlessly sifts through word ambiguities to understand an English statement. However, in cases where a sentence may be equally ambiguous to human beings, the system 10 by necessity produces two or more such permutations as ambiguities from which the user must choose.

To streamline the parsing process of an user sentence, numerals, adverbs, dates and times are transferred from the lexical analysis data listing in memory to another data structure. The position of these items is charted according to their original position in the user sentence. For example, “the Dodgers admirably hit 5 home runs” removes “admirably” and “5” from the lexical analysis data, but charts their positions as occurring just before “hit” and “home runs” respectively.

Phrase extraction also tacitly divides the sentence into recognizable fragments based on the words' status as identifiers and non-identifiers for subsequent processing by the transformational grammar rules. For example, the sentence “the nurses keep clean sheets and blankets in the closet” is divided into fragments based on the words “the”, “and” and “in” as identifiers, and the remaining words as non-identifiers:

{the} {nurses keep clean sheets} {and} {blankets} {in} {the} {closet}.

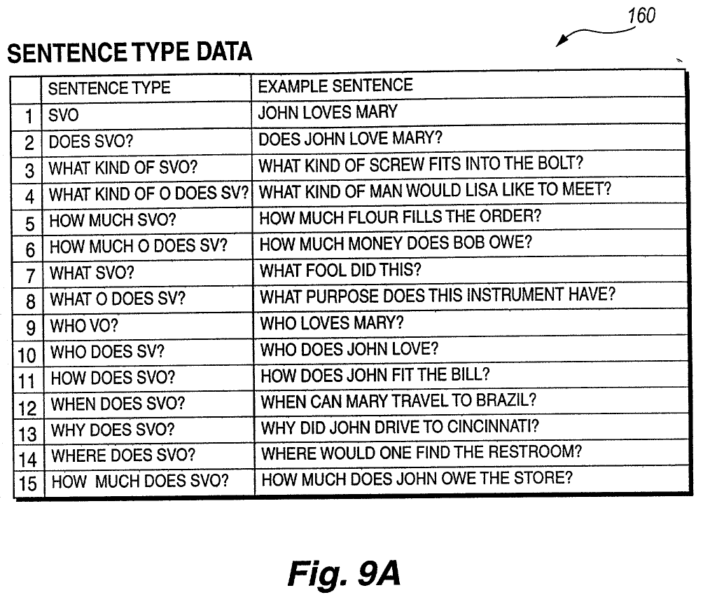

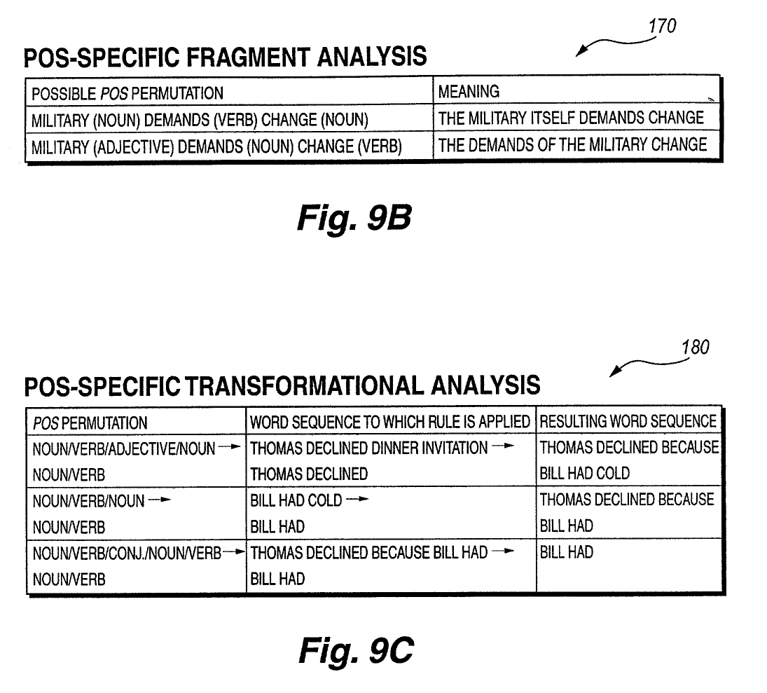

Structural analysis thereafter determines the type of use sentence. The following table (in FIG. 9A) lists the sentence type data 160 those used by the system 10, supplanted by example sentences.

The transformational grammar rules analyzing the user sentence and attempting to deduce the part of speech and sense of each word in the sentence, consist of four sets of rules, executed in the order described below. The first rules involve POS (part of speech) specific phrase structure rules. These rules test each fragment or specific phrase to determine the contextual part of speech of each word within the fragment.

For example, in the sentence “the military demands change under certain circumstances,” the fragment {military demands change} is recognized as the possible POS permutations and meanings depicted in FIG. 9B utilizing POS specific fragment analysis 170.

The second set of rules involve POS-specific transformational analysis 180. These rules test the resulting fragments in tandem to determine the contextual parts of speech for the entire sentence. The rules are successively executed to abbreviate the word sequence and result in a recognizable subject and verb, upon which all grammatically correct sentences are based. One such succession of executed rules, for the sentence “Thomas declined the dinner invitation because Bill had a cold” may include the possible POS permutations, word sequences applied and resulting word sequences depicted in FIG. 9C.

The third set of rules involve concept specific transformational analysis. The results of each POS specific transformational rule applied are tested against one or more concept specific equivalents. Just as POS specific rules narrow the possibilities of sequences of parts of speech, concept specific rules narrow the possibilities of sequences of word senses.

In addition, while POS specific rules diagram the user sentence by reducing it to a recognizable noun and verb, the concept specific rules work in reverse, extending the noun and verb pair back to the original sentence. In so doing, it applies methods in constructing a representation of the user sentence to be processed by the Data Management 130 portion of the system 10.

For example, one POS specific rule that processes the sentence “Thomas saw mountains flying in a plane” (noun-verb-noun-active participle-preposition-article-noun) has two equivalent concept specific rules, the first resulting in a conceptual interpretation that Thomas does the flying, producing the propositions “Thomas see mountains (while) Thomas fly in plane”. The second equivalent concept specific rule results in an interpretation that mountains do the flying, producing the propositions “Thomas see mountains (while) mountains fly in plane”.

Sentence frames, conceptual dependency verb definitions, and constraints limiting the scope of certain word senses to fill clauses in these definitions (all of which are associated with lexical data for words identified as verbs) serve as the criteria by which the system 10 favors the first concept specific rule over the second as the most reasonable understanding of the sentence.

The fourth set of rules involve concept specific fragment analysis. These rules perform the same function as those for concept specific transformational analysis, but tests the results of each POS specific fragment rule applied against one or more concept specific equivalents.

The concept specific rules described above, for both transformational and fragment analysis, contain data with which the system 10 generates a conceptual dependency representation of the entire sentence. This representation is accompanied by propositions, propositional linkages as independent grammatical clauses, optional peripheral data if included in the sentence, and optional subordinate conjunction linkages between independent grammatical clauses if the user sentence consists of two or more such clauses.

For example, the concept specific rules applied to the statement, “The supervisor directed Mary not to type 3 proposal letters at the office for the board of directors on Jan. 15, 2001 so the market analysis would be completed.” where definitions of identified verbs consist of:

“direct”: s:PERSON1*tMTRANS o:PERSON2-c-->s:PERSON2ACT

“type”: s:PERSON1*tMAKE o:OBJECT1 i:“typewriter”

“complete”: s:OBJECT1 DO o:OBJECT2-c-->s:OBJECT2 tf STATE q:“complete”

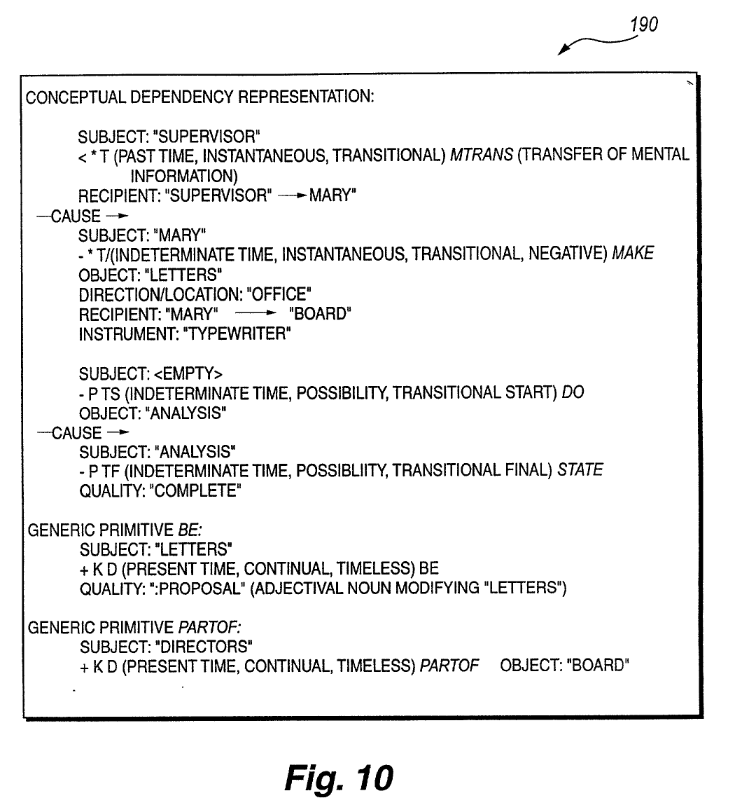

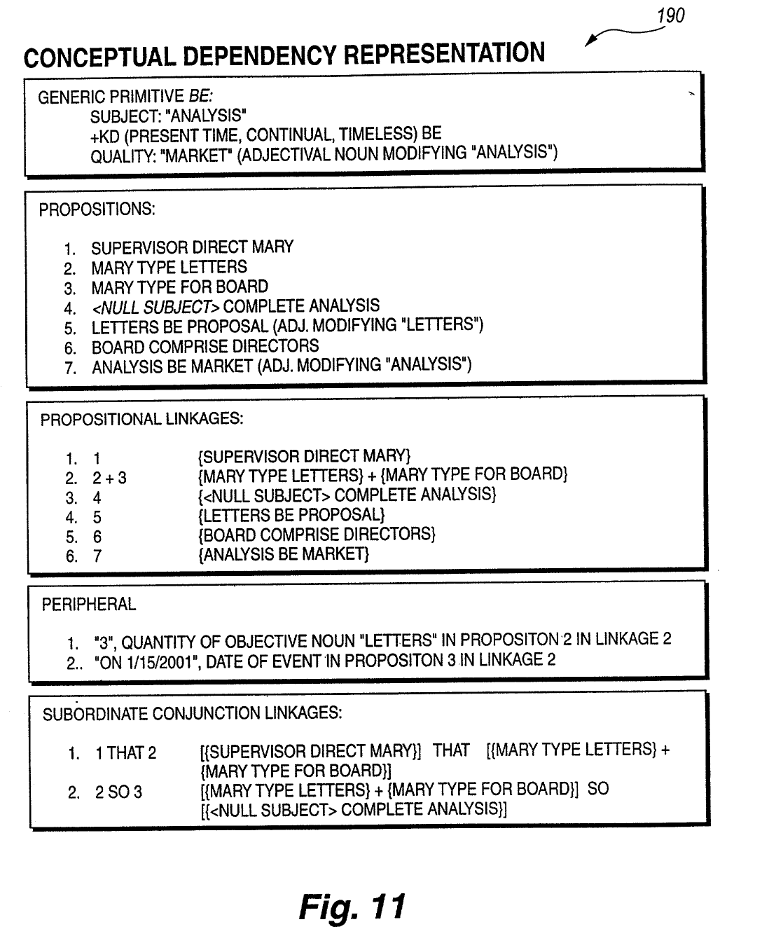

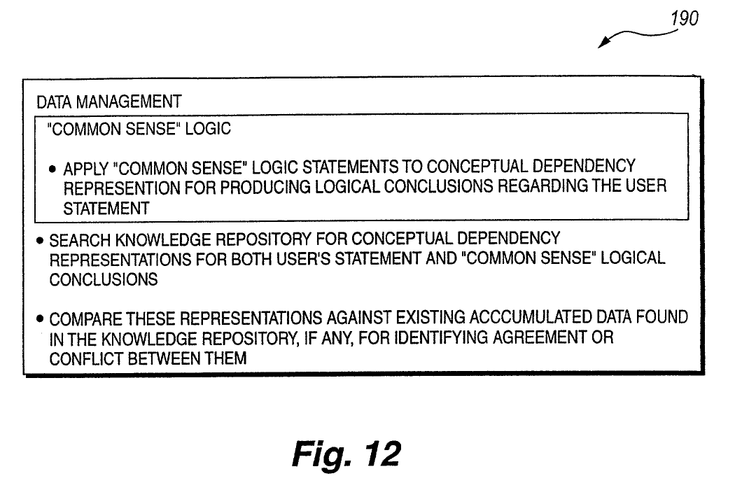

would produce the conceptual dependency representation 190 depicted in FIG. 10 and FIG. 11. FIG. 12 also depicts the data management steps involved with the overall method 100.

The conceptual dependency representation is compared to existing data stored in a relational database resident to the system 10, otherwise referred to as the knowledge depository 70. The knowledge depository 70 accumulates all representational data from previous entry of declarative statements by the user. This comparison is performed on the basis of a synthesis of different types of logic so improvised as to apply to real world events, and thus serves to locate knowledge repository 70 data that may agree or conflict, directly or by logical inference, in responding to the user's declarative statement or in answering the user's question. Data involving the user's declarative statements is added to the knowledge repository 70, if not already present.

The system 10 initially searches a database table containing accumulated propositions for propositions generated by the user sentence. References to individual words in the propositions are made up of record numbers of the words' lexicon entries and an additional numeric code. If a word is used as a noun or adjective, this additional code represents word sense. If a word is used as a verb, this additional code represents a verb primitive combination of this verb's conceptual dependency definition.

For any propositions found, the system 10 then searches a series of database tables containing accumulated propositional links to which propositions found are linked to others. For any propositional linkages found, the system 10 then searches a series of database tables containing peripheral data associated with the found propositional linkages.

Using the first sequential record in a set of peripheral data records found, the system 10 then searches a database table for relevant subordinate conjunction linkages between propositional linkages as independent grammatical clauses. User sentence type, as described earlier, plays a role in whether the system 10 accepts certain data from the knowledge repository 70 as appropriate.

For example, peripheral data with reference to the date and/or time the event occurs would satisfy a user question asking when an event occurs. An independent grammatical clause linked to the user's statement by the subordinate conjunction “because” would satisfy a user question asking why an event occurs. A proposition linked to another with the propositional phrase example “in Italy” as the object would satisfy a user asking where an event occurs. Peripheral data with reference to a numeric quantity would satisfy a user question asking how much of something was involved in an event.

If the system 10 cannot locate the conceptual dependency representation of the user's original statement in the knowledge repository 70, it applies a “common sense” logic to the representation to produce other conceptual dependency representations of events or facts which the representation of the user's original statement may logically infer.

Common sense logic is a synthesis of different types of logic, including syllogistic logic, modal logic, propositional logic and first order predicate calculus so improvised as to apply to a wide variety of real world events. Premises and assertions in common sense logic are expressed in a revised format of Roger Schank's design of conceptual dependency graphs. Clauses in these graphs employ semantic inheritance, where in the lexical analysis of a word may include hyponymic, hypernymic, meronymic and troponymic associations with other entries in the lexicon.

This logical synthesis therefore expands the system's 10 scope of maintaining data integrity throughout the knowledge repository 70. For example, the representation:

subject: “Thomas” <t LOC direction/location: “Italy”

is the underlying meaning of statements such as “Thomas was in Italy,”, “Thomas stayed in Italy” and “Thomas vacationed in Italy”. The common sense logic contains rules by which the system 10 can infer that at one time, Thomas was in Italy, but may or may not be located there at present or in the future.

The following example more clearly illustrates the extended scope of data integrity for testing the validity or truth of a given statement against related data extant in the knowledge repository 70, a statement such as “Thomas vacationed in Italy” is present in the knowledge repository 70. The user then enters a subsequent statement, “no IT programmers ever went to Europe”.

First, lexical analysis reveals that one meronym of “Europe” is “Italy”, meaning that Italy is part of Europe. Secondly, while structural analysis determines the most likely conceptual dependency verb definition verb definition of “go” (infinitive form of went), asserting that if no IT programmers went to Europe or

subject: “IT programmer”/<tPTRANS direction/location: “Europe” a common sense rule infers therefore that:

subject: “IT programmer”/<tLOC direction/location:“Europe” meaning “no IT programmers have been to Europe”, “no IT programmers have vacationed in Europe” or “no IT programmers have stayed in Europe”. Thirdly, another statement previously entered into the knowledge repository 70 may also assert that “Thomas is an IT programmer”.

The system 10 searches for propositions, first on verbs, then on subjects, then on objects, successively transposing possible words and word senses with those originally in the representation of the user statement. These data searches are conducted through a logical process of elimination, so as to reduce the total number of searches to a bare minimum while also ensuring a survey both exhaustive and nearly instantaneous. Thus, one search locates the proposition “Thomas LOC Italy” successively replaced with transposable words starting from “programmer PTRANS Europe”.

Thereafter, the system 10 searches for propositional linkages, any peripheral data and any subordinate conjunction linkages with which these propositions may be associated. Ultimately, the system's 10 programming deduces that since “Thomas vacationed in Italy,” the subsequent user statement “no IT programmers went to Europe,” is false. The user is then given the opportunity of overwriting the earlier data as “an IT programmer went to Europe,” in addition to adding the current user statement.

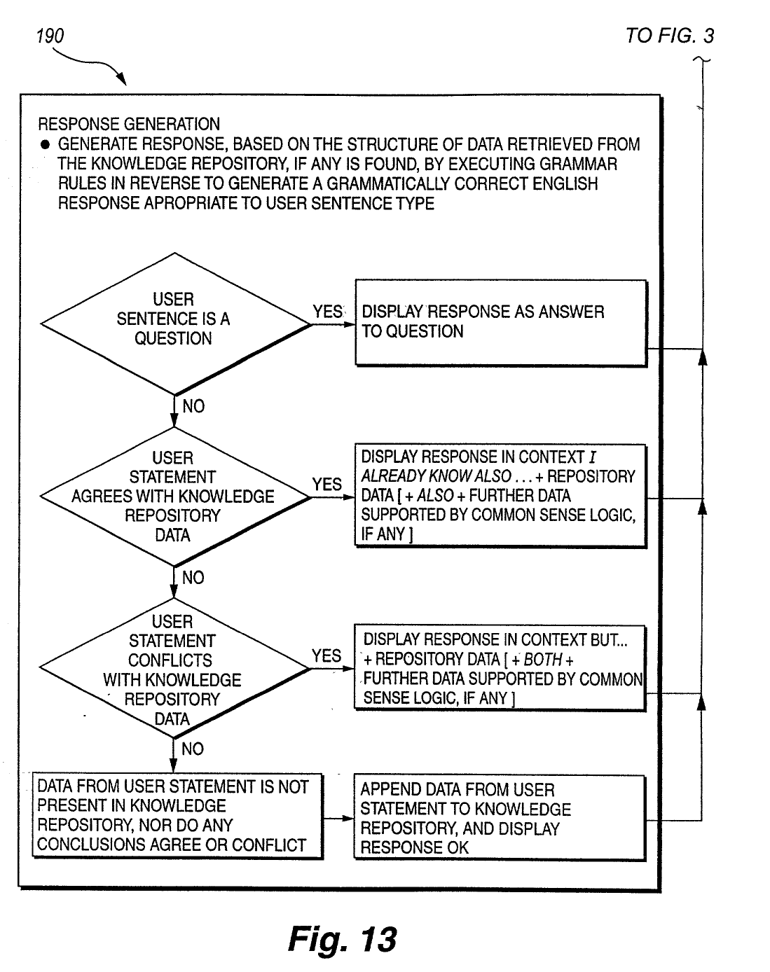

According to FIG. 13, outlining the response generation 140 steps of the system 10, the system 10 locates additional inverse concept specific grammar rules with which to reconstruct a statement from the knowledge repository 70, in the form of a grammatically correct sentence. It does so with respect to the framework of relevant data found in the knowledge repository 70, the user sentence type and results of the common sense logic applied to representations of both the user statement and relevant statements from the knowledge repository 70.

If the user sentence is a question, and if relevant data was found in and derived from the knowledge repository 70, the response is reconstructed and displayed on screen to the user. Otherwise, if data regarding an event indicates the actuality of an event, but no additional data was found appropriate to the user's question, the system 10 displays a response in the format “I don't know who/how much/when/where/why, etc.”+<statement reconstructed from repository data>+“nevertheless”<subject in reconstructed statement>+“does/did/can/would/will, etc.”. Otherwise, if no such relevant data was found, the system 10 displays a response in the format, “I don't know whether”+<statement reconstructed from repository data>+“much less who/how much/when/where/why, etc.”.

If the user sentence is a declarative statement, and if an data found and derived from the knowledge depository 70 conflicts with the user statement, the system 10 displays the response in the format “But”+<statement reconstructed from knowledge repository data 70>, in addition to “because”+<supporting statements from knowledge repository data 70>, if such supporting statements were found to invalidate the user's statement. In this case, the user has the option of overwriting such data so as to agree with the original statement, as well as append the original statement itself to the knowledge repository 70.

Otherwise, if any such data agrees with the user statement, the system 10 response is displayed in the format, “I already know that”+<statement reconstructed from repository data>,+in addition to “because”+<supporting statements reconstructed from knowledge repository data>, if such supporting statements were found to validate the user's statement. Otherwise, no relevant data was found, in which case the system 10 displays “OK”, and appends data to the knowledge repository 70.

It is to be understood that the present invention is not limited to the embodiment described above, but encompasses any and all embodiments within the scope of the following claims.

We claim:

1. A computerized natural language processing system for knowledge management comprising:
an input means for entering data into the system;
at least one server computer having a processor, an area of main memory for executing program code under the direction of the processor, and a disk storage device for storing data and program code;
computer program code stored in disk storage device and executing in the main memory under the direction of the processor;
a knowledge repository with a relational database structure with a plurality of database listings that are integrated and managed within the knowledge repository; and
an output means for generating a response to the data originally input in the system.

2. The computerized natural language processing system for knowledge management, according to claim 1, wherein said input means is a computer keyboard.

3. The computerized natural language processing system for knowledge management, according to claim 1, wherein said plurality of database listings include derived propositions, subordinate conjunction linkages, nouns, logic database listings and peripheral databases.

4. The computerized natural language processing system for knowledge management, according to claim 1, wherein said output means for generating a response to the data originally input in the system, is a computer monitor and printer.

5. A computerized natural language processing method for knowledge management of data, between the system and a user, comprising the steps of:
performing lexical analysis;
performing structural analysis;
performing data management steps; and
generating a response in proper grammatical form.

6. The method according to claim 5, wherein the step of performing lexical analysis further comprises the steps of:
receiving sentences of data by the user;
seeking individual words in the sentence and utilizing the user's sentence in a lexicon to collect lexical data on each word's parts of speech, word senses and semantic associations to other words;
organizing the words from the sentences into synonym sets in the lexicon; and
dividing the lexical data into identifiers and non-identifiers.

7. The method according to claim 5, wherein the step of performing structural analysis further comprises the steps of:
extracting numerals, adverbs, dates and times;
determining a sentence type for each sentence;
deducing the fewest number of permutations of word senses resulting in reasonable meanings and understandings of the sentences;
processing the lexical data using transformational grammar rules involving part of speech (POS) specific phrase structure rules, POS specific transformational rules, concept specific transformational rules and concept specific phrase structure rules; and
constructing a conceptual dependency representation of the sentences from the permutations and the lexical data.

8. The method according to claim 5, wherein the step of performing data management steps, further comprises the steps of:
locating and comparing the conceptual dependency representation to existing data relevant to the user's statement, stored in a relational database and serving as a knowledge repository, which accumulates all data from previous entry by the user;
locating and comparing the conceptual dependency representation utilizing different types of logic to apply to real world events;
utilizing the different types of logic to determine whether existing data agrees or conflicts with the conceptual dependency representation; and
adding data from the conceptual dependency representation to the knowledge repository.

9. The method according to claim 5, wherein the step for generating a response in proper grammatical form further comprises the step of constructing and displaying one or more grammatically correct responses which are appropriate and relevant to the user's data.
